(19) United States
(12) Patent Application Publication
(10) Pub. No.: US 2025/0178388 A1
(43) Pub. Date: Jun. 5, 2025

(54) TRAILER COUPLING

(71) Applicant: Ralf Pietschmann, Loechgau (DE)

(72) Inventor: Ralf Pietschmann, Loechgau (DE)

(73) Assignee: ACPS Automotive GmbH, Ingersheim (DE)

(21) Appl. No.: 19/045,736

(22) Filed: Feb. 5, 2025

Related U.S. Application Data
(63) Continuation of application No. PCT/EP2023/071203, filed on Jul. 31, 2023.

(30) Foreign Application Priority Data
Aug. 8, 2022 (DE) 102022119904.5

(51) Int. Cl. B60D 1/24; B60D 1/06

(52) U.S. Cl. CPC B60D 1/244; B60D 1/06

(57) ABSTRACT

In order to provide a trailer coupling in which the vehicle attachment unit is suitable for crumpling, it is proposed that the vehicle attachment unit should comprise a crumple unit, which is mountable on the vehicle rear below a bumper unit and has an impact body that extends transversely to a longitudinal center plane, which coincides with a vehicle longitudinal center plane, and deformation bodies arranged to either side of the longitudinal center plane, supporting the impact body in relation to the vehicle rear and maintaining a spacing therefrom, that the impact body of the crash unit should be connected to the trailer element, and that the crash unit should transmit to the vehicle rear all the forces that act on the trailer element when the trailer coupling is in use.

### CROSS-REFERENCE TO RELATED PATENT APPLICATION

This application is a continuation of international application number PCT/EP2023/071203 filed on 31 Jul. 2023 and claims the benefit of German application number 10 2022 119 904.5 filed on 8 Aug. 2022.

The present disclosure relates to the subject matter disclosed in international application number PCT/EP2023/071203 of 31 Jul. 2023 and German application number 10 2022 119 904.5 of 8 Aug. 2022, which are incorporated herein by reference in their entirety and for all purposes.

### BACKGROUND OF THE INVENTION

The invention relates to a trailer coupling, comprising a trailer element, in particular a ball neck, and a vehicle attachment unit that carries the trailer element and is mountable or mounted on a vehicle rear.

Trailer couplings of this kind are known from the prior art, but these have the problem that for mounting the known vehicle attachment unit the crash unit that is provided on the vehicle when it is used without a trailer coupling has to be removed and replaced by the vehicle attachment unit, wherein the known vehicle attachment units have no or negligible suitability for crumpling.

In accordance with an embodiment of the invention, a trailer coupling is provided in which the vehicle attachment unit is suitable for crumpling.

### SUMMARY OF THE INVENTION

In accordance with an embodiment of the invention, provision is made in the case of a trailer coupling of the type mentioned in the introduction that the vehicle attachment unit comprises a crumple unit, which is mountable on the vehicle rear below a bumper unit and has an impact body that extends transversely to a longitudinal center plane of the trailer coupling, which coincides with a vehicle longitudinal center plane, and deformation bodies arranged to either side of the longitudinal center plane, supporting the impact body in relation to the vehicle rear and maintaining a spacing therefrom, that the impact body of the crash unit is connected to the trailer element, and that the crash unit transmits to the vehicle rear all the forces that act on the trailer element when the trailer coupling is in use.

The advantage of the solution according to the invention can thus be seen in the fact that on the one hand it provides the possibility that the vehicle attachment unit takes the form of a crash unit in which, in the event of a crash, the impact body acts on the deformation bodies such that these permit movement of the impact body in the direction of the vehicle rear, are deformed during this and absorb energy, and on the other during trailer operation put the crash unit in a position to transmit the forces acting on the trailer element to the vehicle rear without deformation.

Preferably here, the crash unit is a crash unit adapted to the vehicle attachment unit for trailer operation.

However, it is also possible for the crash unit to be a crash unit configured for the motor vehicle and usable on the motor vehicle without the provision of a trailer element.

That is to say that the crash unit itself has the crumple properties and energy absorption properties demanded of the motor vehicle without the trailer coupling, and likewise has these crumple properties when a trailer element is used, but can additionally transmit to the vehicle rear the forces that are transmitted by the trailer element during trailer operation.

In order to configure the crash unit according to the invention for mounting a trailer element, it is preferably provided for a mounting base for mounting the trailer element to be formed on the impact body of the crumple unit.

A mounting base of this kind may be a mounting base for a fixedly mounted trailer element or a removable trailer element, or indeed a mounting base for a pivotal trailer element.

Here, the term “trailer element” is to be understood to mean that it is either configured for connection to a trailer or indeed as a so-called receiver, that is to say a receptacle for a coupling element, or indeed takes a form such that a load carrier, in particular a bicycle carrier, is connectable to it.

In order to give the impact body the required properties for a crash unit in a simple manner, it is preferably provided for the impact body to take the form of a hollow body and thus to have the required stability in the event of a crash to transmit the forces to the deformation bodies, at which a substantial proportion of the provided energy absorption takes place in the event of a crash.

Here, the mounting base could be provided on the impact body, for example on an outer side thereof.

However, a particularly advantageous solution provides for the mounting base to be integrated into the impact body, in order on the one hand not to have any effects that would make the impact body less suitable for crumpling, and on the other additionally to stiffen the impact body so that it is able to transmit to the deformation bodies the forces that occur in the event of impact.

Preferably here, it is provided for the impact body to have a wall element facing the vehicle and a wall element facing away from the vehicle, and for an upper wall element facing away from a road and a lower wall element facing a road to extend between these.

Preferably, all the wall elements are firmly connected to one another, for example being welded or riveted.

A particularly advantageous embodiment of the impact body provides for the wall element facing the vehicle and the upper and lower wall elements extending away from this to be parts of a U-shaped profile.

The most diverse solutions are conceivable as regards connecting the mounting base to the impact body.

One advantageous solution provides for the mounting base to be connected, preferably detachably connected, to the wall element facing the vehicle and the wall element facing away from the vehicle and in particular also to the upper wall element.

Thus, the mounting base serves not only to connect the trailer element to the impact body but also to stabilize the impact body itself, in particular to connect the wall element facing the vehicle to the wall element facing away from the vehicle and where appropriate also to the upper wall element in a central region of the impact body, and thus to increase the stability of the impact body.

In order to enable advantageous installation of the mounting base in the impact body, it is preferably provided for the lower wall element facing a road to have a cutout for installation of the mounting base.

In this case, a cutout of this kind is dimensioned such that the mounting base itself may in all cases simply be inserted into the impact body and connected thereto.

However, it is particularly favorable if the cutout is dimensioned such that it is possible to mount the mounting base with the trailer element previously mounted thereon, where appropriate with a bearing unit on which the trailer element is supported.

It is particularly advantageous if there is held on the mounting base a bearing unit, in particular a pivotal bearing unit, for the trailer element, by which the trailer element is pivotal from a working position into a rest position.

In this case too, the mounting base, together with the pivotal bearing unit and the trailer element, is intended to be insertable and mountable in the impact body by way of the cutout in the wall element facing a road.

Moreover, advantageously it is provided for the trailer element in the rest position to be at least partly, in particular entirely, received in the impact body, wherein for this purpose favorably the cutout for mounting the mounting base is likewise dimensioned to be large enough to be able to insert the trailer element, which in the rest position extends in particular transversely to the longitudinal center plane, into the impact body at least partly or entirely, and to position it there in the rest position.

Likewise, no further statements have yet been made as regards connecting the deformation bodies to the vehicle rear.

Thus, one advantageous solution provides for the respective deformation body to be supported on a foot that abuts or is configured to abut against the vehicle rear.

Preferably, for this purpose each of the feet is provided with a central region that takes a planar form and enables planar support against the vehicle rear.

In order to connect the feet to the vehicle rear, it is preferably provided for the feet to be fixable to the vehicle rear by way of anchoring elements.

In particular in this case, the feet are provided with anchoring elements acting on a stabilized region of the vehicle rear.

More detailed statements have not yet been made as regards the form taken by the deformation bodies.

Fundamentally, the deformation bodies could take any form enabling sufficient energy absorption in the event of a crash.

It is particularly favorable if the deformation bodies have connection elements arranged between the respective foot and a holding region of the impact body.

Preferably, for this purpose the connection elements comprise fingers that are firmly connected to the holding region of the impact body.

Preferably, for this purpose it is provided for the fingers to abut against the lower and upper wall elements of the impact body and to be connected to holding regions thereof.

Moreover, for the purpose of additionally supporting the impact body, it is provided for the connection elements to have a supporting web that extends between the fingers and stabilizes at least the fingers relative to one another.

In particular, provided in the respective connection element between the supporting web and the respective foot is a central opening, which favors deformability of the supporting web in the direction of the respective foot.

It is particularly favorable if the wall element of the impact body that faces the vehicle abuts against the supporting web and is in particular firmly connected thereto, with the result that this provides a further support for the impact body against the connection elements.

In order, in addition to the above connections between the impact body and the connection elements, to provide a yet further support, it is preferably provided for the wall element facing away from the vehicle to abut on the fingers, in particular on the end regions of the fingers, and thus also itself to be supported directly on the fingers.

In order in the event of a crash to enable the connection element to deform, in particular in the region of the fingers, it is preferably provided for the holding regions, which are connected to the fingers, of the upper and lower wall elements to be decoupled from the wall element facing the vehicle by cutouts such that the holding regions of the upper and lower wall elements may, together with the fingers, be deformed independently of the wall element facing the vehicle, in order in the event of a crash to absorb as much crash energy as possible.

In particular, it is provided for the connection elements to take a form such that in the event of a crash they deform as a whole in the direction of the crash, that is to say that the connection elements do not only deform as individual parts but all the connection elements undergo deformation in the direction of the crash in order to take up as much crash energy as possible.

For example, during this, in their regions adjoining the supporting web the fingers move toward or away from one another, and the supporting web moves in the direction of the foot, in particular reducing the extent of the central opening.

In case the crash energy to be taken up by the connection elements in the event of a crash is not sufficient, it is preferably provided for additional energy absorption elements, which in the event of a crash deform in the direction of the crash, to be associated with the connection elements of the deformation bodies.

However, additional energy absorption elements of this kind may for example not only serve to absorb energy in the event of a crash but may also for example additionally be configured to transmit to the feet forces that are transmitted from the trailer element to the impact body.

A particularly advantageous embodiment of the additional energy absorption elements that deform in the event of a crash provides for them to be bodies that fold up in the direction of the crash, that is to say that they fold up such that the spacing between the feet and the impact body is reduced, and thus additional energy is absorbed by the additional energy absorption elements.

For example, the additional energy absorption elements are constructed such that they have a central body and, extending from this, support elements that run at one side to the foot and at the other side to the impact body and in the event of a crash deform, for example fold up.

Another advantageous solution provides for the additional energy absorption elements to take the form of hollow bodies.

In this case, the hollow bodies are preferably formed such that they extend around a geometric axis, and such that the geometric axis runs in the direction of a crash or transversely to the direction of a crash.

Thus, the above description of solutions according to the invention comprises in particular the different combinations of features that are defined by the sequentially numbered embodiments below:

1. A trailer coupling (30), comprising a trailer element (40), in particular a ball neck (42), and a vehicle attachment unit (20) that carries the trailer element (40) and is mountable or mounted on a vehicle rear (14), wherein the vehicle attachment unit (20) comprises a crash unit (60), which is mountable on the vehicle rear (14) below a bumper unit (16) and has an impact body (62) that extends transversely to a longitudinal center plane (18), which coincides with a vehicle longitudinal center plane (18), and deformation bodies (64) arranged to either side of the longitudinal center plane (18), supporting the impact body (62) in relation to the vehicle rear (14) and maintaining a spacing therefrom, wherein the impact body (62) of the crash unit (60) is connected to the trailer element (40), and wherein the crash unit (60) transmits to the vehicle rear (14) all the forces that act on the trailer element (40) when the trailer coupling (30) is in use.

2. The trailer coupling according to embodiment 1, wherein the crash unit (60) is a crash unit adapted to the vehicle attachment unit (20) for trailer operation.

3. The trailer coupling according to embodiment 1 or 2, wherein the crash unit (60) is a crash unit (60) configured for the motor vehicle (10) and usable on the motor vehicle (10) without the provision of a trailer element (40).

4. The trailer coupling according to one of the preceding embodiments, wherein a mounting base (70) for mounting the trailer element (40) is held on the impact body (62) of the crash unit (60).

5. The trailer coupling according to one of the preceding embodiments, wherein the impact body (62) takes the form of a hollow body.

6. The trailer coupling according to one of the preceding embodiments, wherein the mounting base (70) is integrated into the impact body (62).

7. The trailer coupling according to one of the preceding embodiments, wherein the impact body (62) has a wall element (82) facing the vehicle and a wall element (88) facing away from the vehicle, and wherein an upper wall element (84) facing away from a road and a lower wall element (86) facing a road extend between these.

8. The trailer coupling according to embodiment 7, wherein the wall elements (82, 84, 86, 88) are firmly connected to one another.

9. The trailer coupling according to one of the preceding embodiments, wherein the wall element (82) facing the vehicle and the upper and lower wall elements (84, 86) extending away from this are parts of a U-shaped profile.

10. A trailer coupling according to one of the preceding embodiments, wherein the wall element (88) facing away from the vehicle is convexly curved in the direction away from the wall element (82) facing the vehicle.

11. The trailer coupling according to one of the preceding embodiments, wherein the mounting base (70) is connected, preferably detachably connected, to the wall element (82) facing the vehicle and the wall element (88) facing away from the vehicle and in particular also to the upper wall element (84).

12. The trailer coupling according to one of the preceding embodiments, wherein the lower wall element (86) facing a road has a cutout (92) for installation of the mounting base (70).

13. The trailer coupling according to embodiment 12, wherein the cutout (92) is dimensioned such that it is possible to mount the mounting base (70) with the trailer element (40) previously mounted thereon.

14. The trailer coupling according to one of the preceding embodiments, wherein held on the mounting base (70) is a bearing unit (72), in particular a pivotal bearing unit, for the trailer element (40), by which the trailer element (40) is pivotal from a working position (A) into a rest position (R).

15. The trailer coupling according to embodiment 14, wherein in the rest position (R) the trailer element (40) is at least partly, in particular entirely, received in the impact body (62).

16. The trailer coupling according to one of the preceding embodiments, wherein, in the central region receiving the mounting base (70), the lower wall element (88) is provided with a cutout (92) of which the extent is such that the mounting unit (70), together with the pivotal bearing unit (72) mounted thereon, is insertable between the wall element (82) facing the vehicle and the wall element (88) facing away from the vehicle and is mountable integrated into the impact body (62), such that in particular the entire mounting base (70), together with the bearing unit (72), lies within the impact body (62).

17. The trailer coupling according to embodiment 16, wherein the mounting base (70) runs obliquely relative to both the wall element (88) facing away from the vehicle and the wall element (82) facing the vehicle and abuts against them by way of mounting flanges (96, 94).

18. The trailer coupling according to embodiment 17, wherein the mounting unit (70) has an additional mounting flange (98) that is configured to abut against the upper wall element (84) and to be connected thereto.

19. The trailer coupling according to one of the preceding embodiments, wherein the mounting base (70), with the bearing unit (72) mounted thereon and together with the trailer element (40) held by the bearing unit (72), is insertable as a whole into the impact body (62) by way of a cutout (92) in the lower wall element (86).

20. The trailer coupling according to embodiment 19, wherein the mounting base (70) is connectable to the wall element (82) facing the vehicle by way of a mounting flange (94) and to the wall element (88) facing away from the vehicle by way of a mounting flange (96) and to the upper wall element (84) by way of a mounting flange (98).

21. The trailer coupling according to one of the preceding embodiments, wherein the mounting base (70) is detachably connectable to the wall elements (82, 84, 88) by way of the mounting flanges (94, 96, 98).

22. The trailer coupling according to one of the preceding embodiments, wherein the mounting base (70) is connectable to the wall elements (82, 84, 88) by way of the mounting flanges (94, 96, 98) using screws.

23. The trailer coupling according to one of the preceding embodiments, wherein the mounting base (70) is formed from molded parts (102, 103) made of flat material that are connected to one another and are for example mutually overlapping or arranged at a spacing from one another.

24. The trailer coupling according to one of the preceding embodiments, wherein the mounting base (70′) is configured as a solid component that is connectable by way of edge regions (104, 106, 108) respectively to the wall element (82) facing the vehicle, the wall element (88) facing away from the vehicle and the upper wall element (84).

25. The trailer coupling according to one of the preceding embodiments, wherein the respective deformation body (64) is supported on a foot (66) that abuts or is configured to abut against the vehicle rear (14).

26. The trailer coupling according to embodiment 25, wherein each of the feet (66) has a central region (124) that takes a planar form.

27. The trailer coupling according to embodiment 25 or 26, wherein the feet (66) are fixable to the vehicle rear (14) by way of anchoring elements (116, 118).

28. The trailer coupling according to embodiment 27, wherein the feet (66) are provided with anchoring elements (116, 118) acting on a stabilized region of the vehicle rear (14).

29. The trailer coupling according to one of the preceding embodiments, wherein the deformation bodies (64) have connection elements (122) arranged between the respective foot (66) and a holding region (152) of the impact body (62).

30. The trailer coupling according to embodiment 29, wherein the connection elements (122) have fingers (126, 128) that are firmly connected to the holding region (152) of the impact body (62).

31. The trailer coupling according embodiment 30, wherein the fingers (126, 128) abut against the lower and upper wall elements (84, 86) of the impact body (62) and are connected to holding regions (152) thereof.

32. The trailer coupling according to embodiment 30 or 31, wherein the connection elements (122) have a supporting web (142) that extends between the fingers (126, 128), and wherein provided in particular in the respective connection element (122) between the supporting web (142) and the foot (66) is a central opening (143).

33. The trailer coupling according to embodiment 32, wherein the wall element (82) of the impact body (62) that faces the vehicle abuts against the supporting web (142) and is in particular firmly connected thereto.

34. The trailer coupling according to one of embodiments 30 to 33, wherein the wall element (88) facing away from the vehicle abuts on the fingers (126, 128).

35. The trailer coupling according to one of embodiments 30 to 34, wherein the holding regions (152), which are connected to the fingers (126, 128), of the upper and lower wall elements (84, 86) are decoupled from the wall element (82) facing the vehicle by cutouts (154).

36. The trailer coupling according to one of embodiments 29 to 35, wherein the connection elements (122) take a form such that in the event of a crash they deform as a whole in the direction of the crash (156).

37. The trailer coupling according to one of embodiments 29 to 36, wherein additional energy absorption elements (162), which in the event of a crash deform in the direction of the crash (156), are associated with the connection elements (122) of the deformation bodies (64).

38. The trailer coupling according to embodiment 37, wherein the additional energy absorption elements (162) are configured to take up forces that are transmitted from the trailer element (40) to the impact body (62).

39. The trailer coupling according to embodiment 37 or 38, wherein the additional energy absorption elements (162) take the form of bodies that fold up in the direction of a crash (156).

40. The trailer coupling according to one of embodiments 37 to 39, wherein the additional energy absorption elements (162, 162′″) have a central body (164, 195) and, extending from this, support elements (166, 168, 196, 198) that run at one side to the foot (66) and at the other side to the impact body (62) and in the event of a crash are foldable in the direction of the crash (156).

41. The trailer coupling according to one of embodiments 37 to 40, wherein the additional energy absorption elements (162′, 162″) take the form of hollow bodies (172, 174, 182, 184).

42. The trailer coupling according to embodiment 41, wherein the hollow bodies (172, 174, 182, 184) extend around a geometric axis (176, 186), and wherein the geometric axis (176, 186) runs in the direction of a crash (156) or transversely to the direction of a crash (156).

Further features and advantages of the invention form the subject matter of the description below and the representation in the drawing of some exemplary embodiments.

### BRIEF DESCRIPTION OF THE DRAWINGS

FIG. 1 shows a side view of a motor vehicle having a trailer coupling according to the invention mounted thereon;

FIG. 2 shows a rear view of the motor vehicle according to FIG. 1, provided with the trailer coupling according to the invention;

FIG. 3 is a perspective illustration of a vehicle attachment unit, with a trailer element of a first exemplary embodiment of a trailer coupling according to the invention;

FIG. 4 shows a plan view of the trailer coupling according to FIG. 3, as seen from a road;

FIG. 5 shows a rear view of the trailer coupling according to FIG. 3;

FIG. 6 shows a plan view, seen in the direction of a road, of the trailer coupling according to FIG. 3;

FIG. 7 is a perspective illustration of a mounting base, with a trailer element mounted using a pivotal bearing unit;

FIG. 8 is an illustration of a detail of a first version of the mounting base of the trailer coupling according to the invention;

FIG. 9 is an illustration of a second version of the mounting base according to the invention;

FIG. 10 is a side view of the trailer coupling, with the deformation bodies configured each to take the form of a connection element;

FIG. 11 is an enlarged perspective illustration of the deformation body that is facing the viewer in FIG. 10;

FIG. 12 is a section along the line 12-12 in FIG. 11, before a crash;

FIG. 13 is a section along the line 12-12 in FIG. 11, after a crash;

FIG. 14 is an illustration of a second exemplary embodiment of a trailer coupling according to the invention, with a deformation body comprising a connection element and an additional energy absorption element;

FIG. 15 is an enlarged perspective illustration, with a view of the deformation body according to FIG. 14 from above left;

FIG. 16 is an illustration of just the additional energy absorption element of the deformation body of the second exemplary embodiment, according to FIG. 14;

FIG. 17 is an illustration of just the additional energy absorption element of the deformation body of the second exemplary embodiment, with a view in the direction of the arrow X in FIG. 16;

FIG. 18 shows a first variant of an additional energy absorption element according to the invention, illustrated as part of the deformation element in conjunction with the connection element;

FIG. 19 is an illustration of just the first variant of the additional energy absorption element according to FIG. 18;

FIG. 20 is a second variant of the additional energy absorption element, illustrated as part of the deformation element in conjunction with the respective connection element;

FIG. 21 is an illustration of just the second variant of the additional energy absorption element according to FIG. 20;

FIG. 22 is an illustration of a third variant of the additional energy absorption element, as part of the deformation element in conjunction with the connection element; and

FIG. 23 is an illustration of just the third variant of the additional energy absorption element according to FIG. 22.

### DETAILED DESCRIPTION OF THE INVENTION

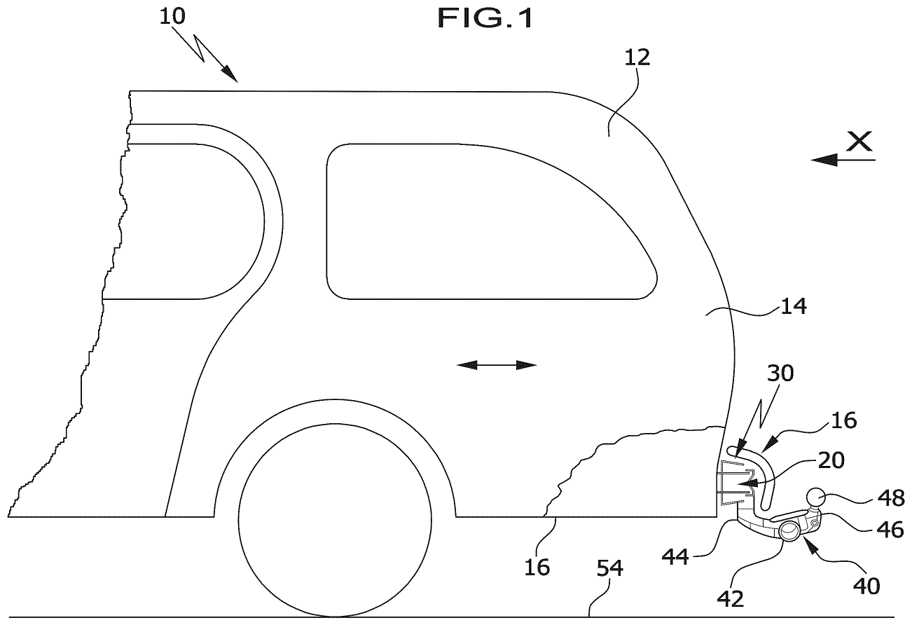

The invention relates to a motor vehicle 10 which has a vehicle body 12 that carries at a vehicle rear 14 a bumper unit designated 16 as a whole (FIG. 1).

A vehicle attachment unit designated 20 as a whole is arranged at the vehicle rear 14 and hidden by the bumper unit 16, and is part of a trailer coupling which is designated 30 as a whole and which, in addition to the vehicle attachment unit 20, carries a trailer unit 40 taking the form in particular of a ball neck 42, wherein the trailer unit 40 extends from a first end 44 connected to the vehicle attachment unit 20 to a second end 46 carrying a coupling element 48 taking the form for example of a coupling ball.

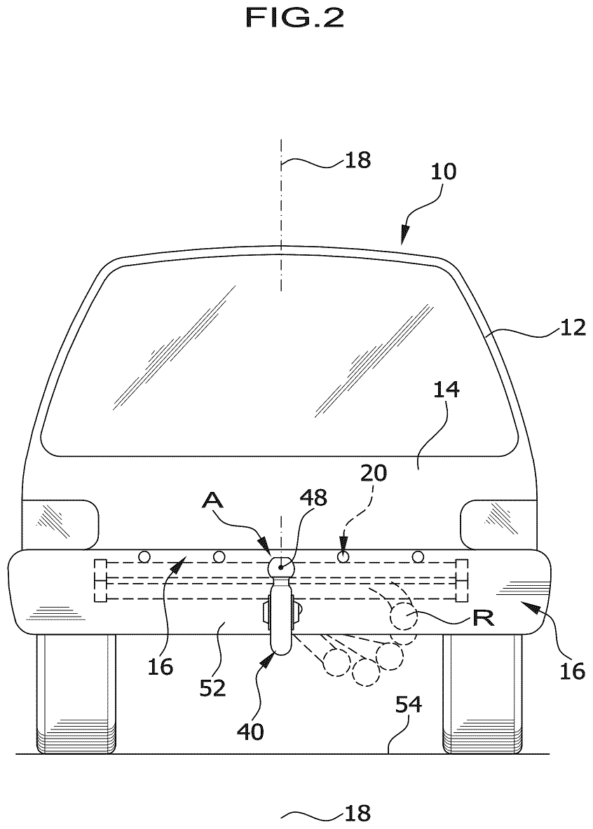

As illustrated in FIG. 2, in the case of an advantageous exemplary embodiment it is provided for the trailer element 40 to be movable from a working position A, in which the coupling element 48 is arranged substantially symmetrically in relation to a longitudinal center plane 18 of the trailer coupling 30 that coincides with the vehicle longitudinal center plane, through below a lower edge 52 of the bumper unit 16 that faces a road and into a rest position R, in which the trailer element 40 is in a rest position R with the coupling element 48 hidden by the bumper unit 16.

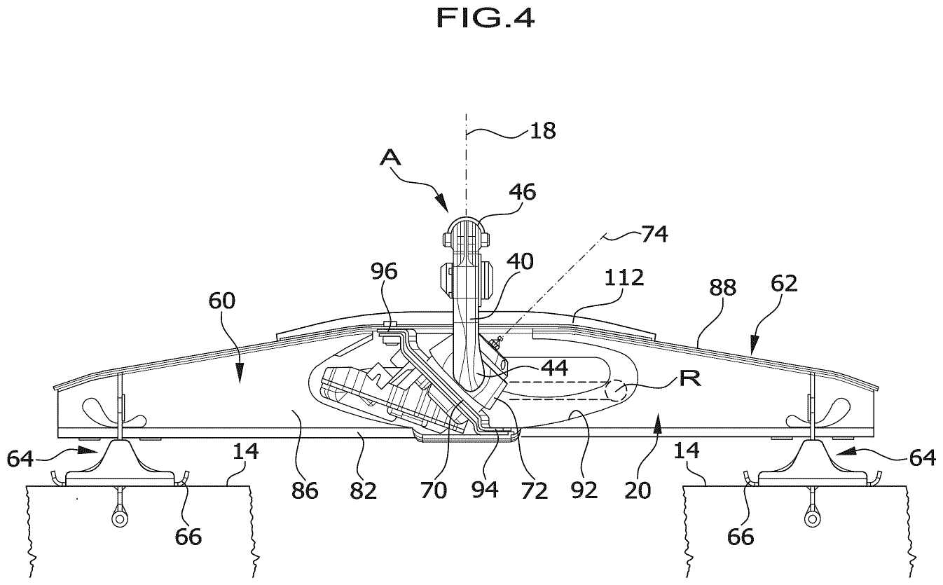

This is performed for example by a pivotal movement about a pivot axis that is not perceptible in FIGS. 1 and 2 but is perceptible for example in FIG. 4.

Further, as illustrated in FIG. 2, it is provided for the vehicle attachment unit 20 to extend on either side of the longitudinal center plane 18, hidden by the bumper unit 16.

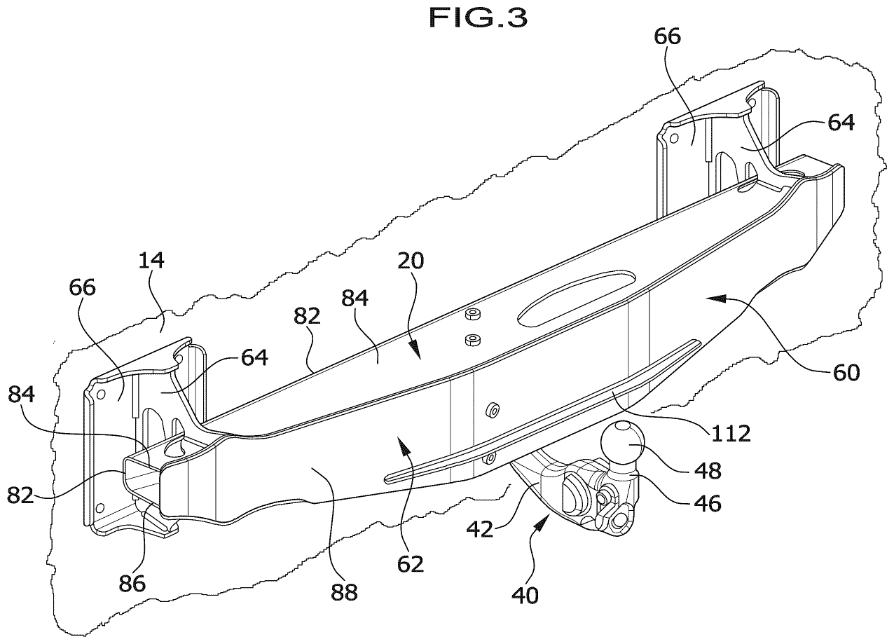

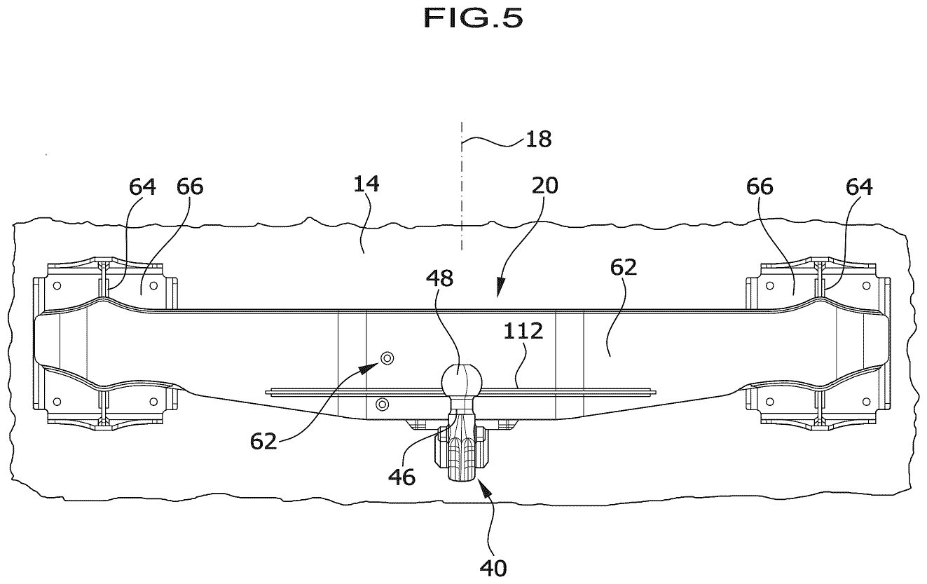

As illustrated in FIGS. 3 to 5, the vehicle attachment unit 20 takes the form of a crash unit 60 that has an impact body 62 which extends transversely to the longitudinal center plane 18 and is supported at the vehicle rear 14 by deformation bodies 64 arranged between the impact body 62 and the vehicle rear 14, which for their part abut or are abuttable against the vehicle rear 14, and are connected or connectable to the vehicle rear 14, by way of feet 66.

Here, in the solution according to the invention both the impact body 62 and the deformation bodies 64 and the feet 66 are respectively configured such that they not only transmit the forces provided for the motor vehicle 10 to the vehicle rear 14 in the event of a crash and absorb at least some of the crash energy in the region of the deformation bodies 64, but are also configured such that they are able to take up the forces from the trailer element 40 that occur during operation of a trailer or a load or bicycle carrier and transmit these to the vehicle rear 14.

For this purpose, in the illustrated exemplary embodiment the impact body 62 takes the form of a hollow body in which is arranged a mounting base designated 70, on which the trailer element 40 is supported by way of a bearing unit, which is designated 72 as a whole and takes the form for example of a pivotal bearing unit by which the trailer element 40 is mounted to be pivotal about for example a pivot axis 74, in order to move the trailer element 40 from the working position A, in which the trailer element 40 is shown in solid lines, into the rest position R, which in FIG. 4 is illustrated in dashed lines.

Here, the bearing unit 72 comprises in particular on the one hand a locking unit, in order to fix the trailer element 40 in the working position A and the rest position R, and on the other for example also an in particular electric pivot drive by which the pivotal movement of the trailer element 40 from the working position A into the rest position R and vice versa is performable.

As illustrated in FIGS. 3 to 6, the impact body 62 is formed by a wall element 82 facing the vehicle from which there extend, in the direction of a wall element 88 facing away from the vehicle, an upper wall element 84 facing away from a road and a lower wall element 86 facing a road.

For example, the wall element 82 facing the vehicle, the upper wall element 84 and the lower wall element 86 are formed by a U-shaped profile, for example a deep-drawn part or extruded part, of which the middle limb forms the wall element 82 facing the vehicle and the side limbs form the upper wall element 84 and the lower wall element 86, in which case the upper wall element 84 and the lower wall element 86 each extend as far as the wall element 88 facing away from the vehicle and are firmly connected thereto.

In this case, for example the wall element 88 facing away from the vehicle is formed by a flat material that is welded, at least in certain regions, to the upper wall element 84 and the lower wall element 86 over their extent transversely to the longitudinal center plane 18.

Further, for example the wall element 88 facing away from the vehicle takes a form that is convexly curved in the direction away from the wall element 82 facing the vehicle, with the result that there is sufficient space in the region of the mounting base 70 for it to be received between the wall element 82 facing the vehicle and the wall element 88 facing away from the vehicle.

Further, in the central region receiving the mounting base 70, the lower wall element 86 is provided with a cutout 92 of which the extent is such that the mounting base 70, together with the pivotal bearing unit 72 mounted thereon, is insertable between the wall element 82 facing the vehicle and the wall element 88 facing away from the vehicle and is thus mountable integrated into the impact body 62, such that in particular the entire mounting base 70, together with the bearing unit 72, lies within the impact body 62.

For the purpose of suitably orienting the bearing unit 72 and thus the pivot axis 74, the mounting base 70 runs obliquely relative to both the wall element 82 facing the vehicle and the wall element 88 facing away from the vehicle and abuts against them by way of mounting flanges 94 and 96 respectively.

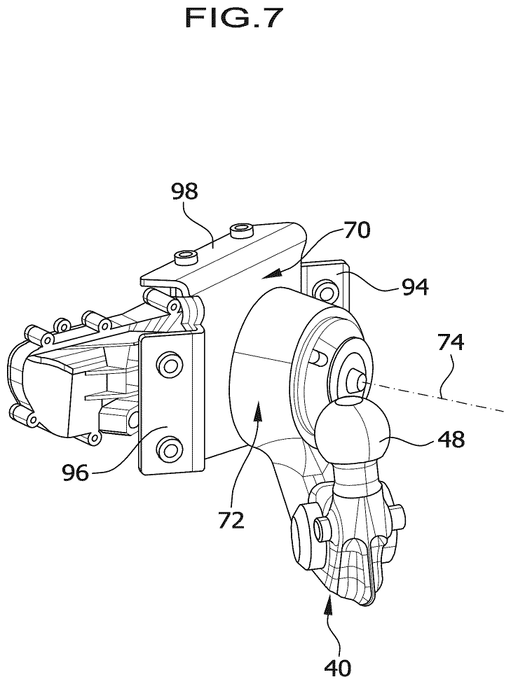

Furthermore, as illustrated in FIG. 7, the mounting unit 70 has another mounting flange 98 that is configured to abut against the upper wall element 84 and to be connected thereto.

Thus, the mounting base 70, with the bearing unit 72 mounted thereon and together with the trailer element 40 held by the bearing unit 72, as illustrated in FIG. 7, is insertable as a whole into the impact body 70 by way of a cutout 92 in the lower wall element 86, and is connectable, in particular detachably connectable, for example by screws, to the wall element 82 facing the vehicle by way of the mounting flange 94 and to the wall element 88 facing away from the vehicle by way of the mounting flange 96 and to the upper wall element 84 by way of the mounting flange 98, such that a simplified way of integrating and mounting the mounting body 70 with the bearing unit 72 and the trailer element 40 is available.

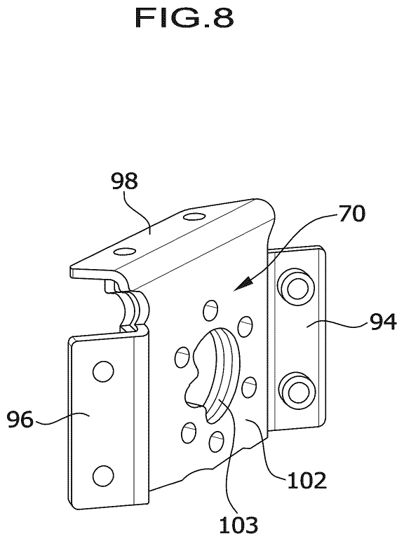

Preferably for this purpose, as illustrated in FIG. 8, the mounting base 70 is formed from molded parts 102 and 103 made of flat material that are connected to one another and are for example mutually overlapping or arranged at a spacing from one another and enable a high degree of flexibility in the shaping of the mounting base 70.

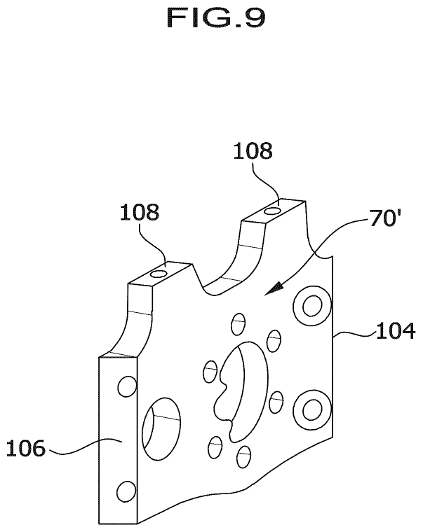

As an alternative to this, however, and as illustrated in FIG. 9, the mounting base 70′ is also configurable as a solid component that is connectable by way of edge regions 104, 106 and 108 respectively to the wall element 82 facing the vehicle, the wall element 88 facing away from the vehicle and the upper wall element 84.

For the purpose of improving the stiffness of the impact body 62 taking the form of a hollow body, in particular in the region of the cutout 92, preferably the wall element 88 facing away from the vehicle is provided with a stiffening rib 112, which is for example arranged on and connected to the wall element 88 facing away from the vehicle on a side thereof that faces away from the vehicle.

Further, preferably, the upper wall element 84 is provided with a cutout 114 that improves accessibility to the mounting base 70 and forms for example a free space in which the trailer element 40 can engage, where appropriate also only partially, in the rest position R.

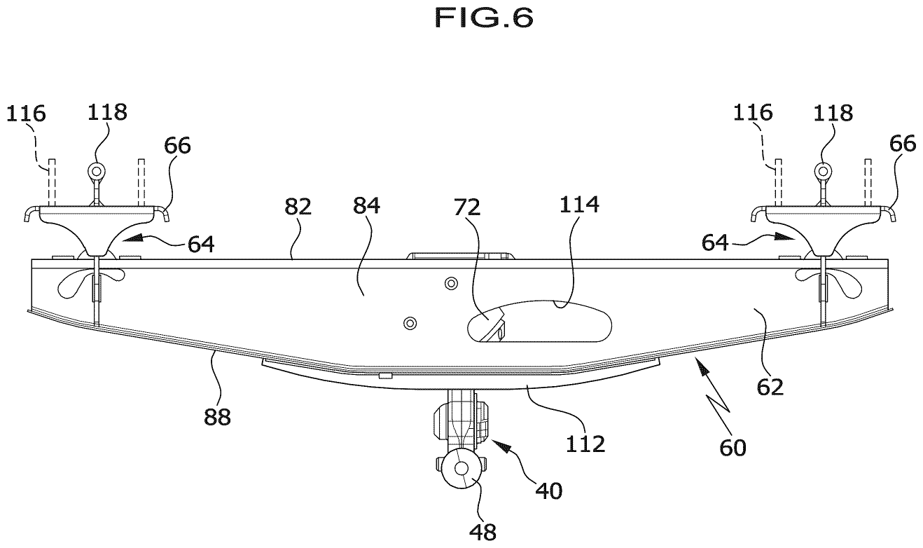

For the purpose of fixing the feet 66 to the vehicle rear 14, they are preferably mountable by way of anchoring elements 116 engaging in the vehicle rear 14.

Where appropriate, additional anchoring elements 118 that are fixable in the vehicle rear are provided, as illustrated in FIG. 6.

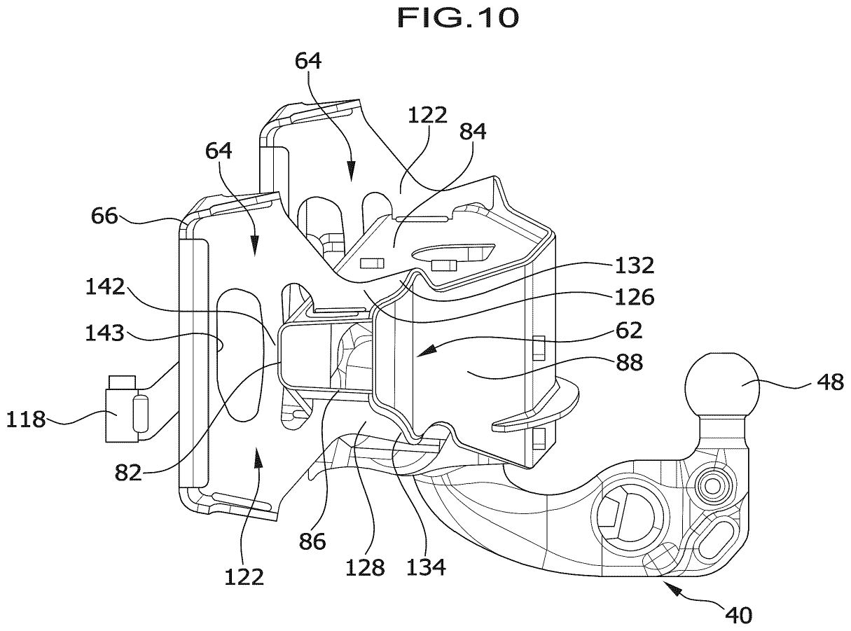

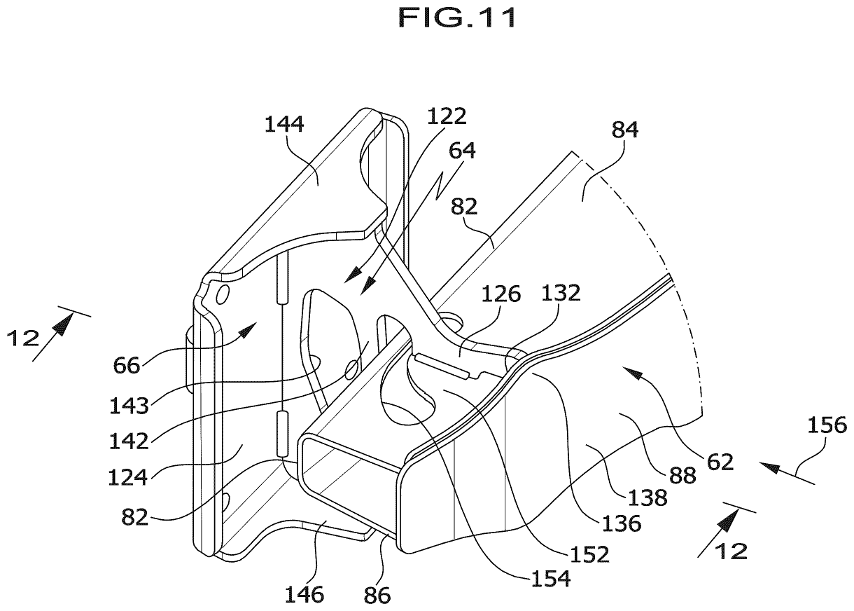

As illustrated in FIGS. 10 and 11, each of the deformation elements 64 comprises a deformable connection element 122 which is held on one side against the foot 66 and preferably extends transversely, in particular approximately perpendicular, to a central region 124 of the foot 66 taking a planar form, in the direction of and as far as the impact body 62.

For the purpose of connecting it to the impact body 62, the connection element 122 has two fingers 126, 128, wherein the finger 126 abuts against and is connected to the upper wall element 84 and the finger 128 abuts against and is connected to the lower wall element 86.

Further, the fingers 126 and 128 extend as far as the wall element 88 facing away from the vehicle, and abut against this in each case by an end region 132 and 134 respectively such that the wall element 88 facing away from the vehicle is directly supported by the fingers 126, 128.

For example, for this purpose the wall element 88 facing away from the vehicle has projections 136 and 138 which are thus supported directly on the end regions 132 and 134 of the fingers 126, 128.

Further, the connection element 122 comprises a supporting web 142 that extends between the fingers 126 and 128 and abuts against the wall element 82 facing away from the vehicle and hence supports it.

Preferably, moreover provided in the connection element 122 between the supporting web 142 and the foot 66 is a central opening 143 which provides the possibility for the supporting web 142 to move in the direction of the foot 66 and deform in the event of a crash.

For the purpose of stabilizing the connection elements 122 relative to the foot 66, the feet 66 moreover have shaped regions 144 and 146 that extend in the same direction as the respective connection element 122 but transversely thereto and receive the connection element 122 between them in its region extending approximately as far as the supporting web 142, and hence stabilize it.

Preferably, in this way each of the connection elements 122 is firmly connected to the corresponding foot 66 on the one hand by the planar central region 124 and on the other by the shaped regions 144 and 146.

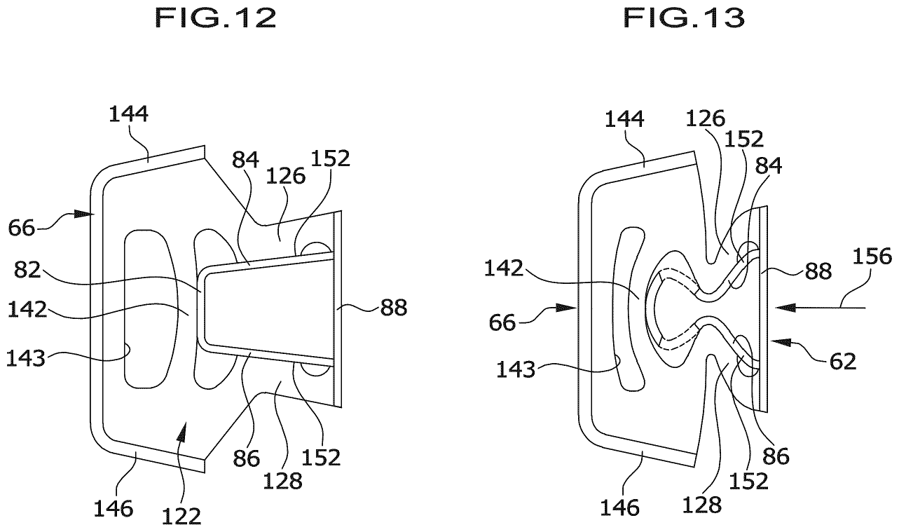

As a result of this connection between the foot 66 and the respective connection element 122, and the connections between this and the impact body 62, the unit comprising the impact body 62 and the deformation bodies 64 is thus able to transmit to the feet 66 forces acting through the trailer element 40 and on the impact body 62 transversely and parallel thereto, wherein these forces are then also introduced in turn through the feet 66 and into the vehicle rear 14. (FIG. 12)

In order, in the event of a crash, to facilitate deformation of the connection body 122, the holding regions 152 of the upper wall element 84 and the lower wall element 86, which are connected to the fingers 126 and 128, are freed for movement in relation to the wall element 82 facing the vehicle by a cutout 154, such that in the event of a crash it is possible for the fingers 126 and 128 of the connection element 122 to move toward one another together with the holding regions 152 of the impact body 62, and moreover for the supporting web 142, urged by the wall region 82 of the impact body 62 that faces the vehicle, to move in the direction of the foot 66 so that the central opening 143 is made smaller, with the result that because the fingers 126, 128 move toward one another and the supporting web 142 moves in the direction of the foot 66, and in conjunction with a deformation of the impact body 62 in the holding regions 152, the entire connection element 122 enables movement of the impact body 62 in the direction of a crash 156, that is to say in the direction of the feet 66, and as a result of the ensuing deformations absorbs energy. (FIG. 13)

Depending on the respective specifications for energy that is to be taken up by the deformation bodies 64 in the event of a crash, the connection elements 122 are not always in a position to absorb high levels of energy sufficiently by deformation.

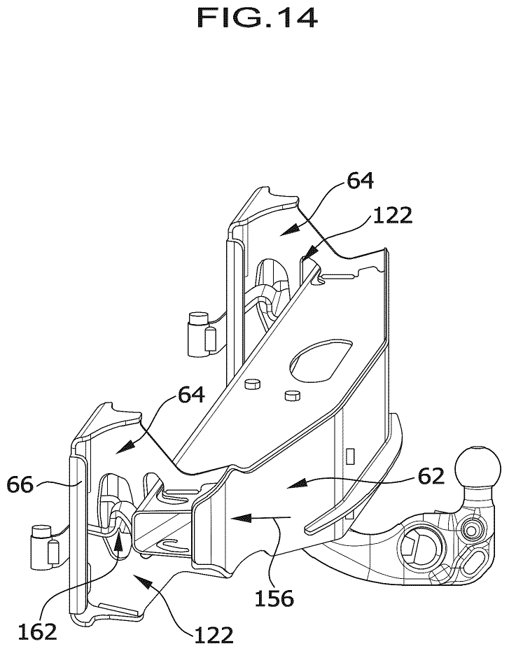

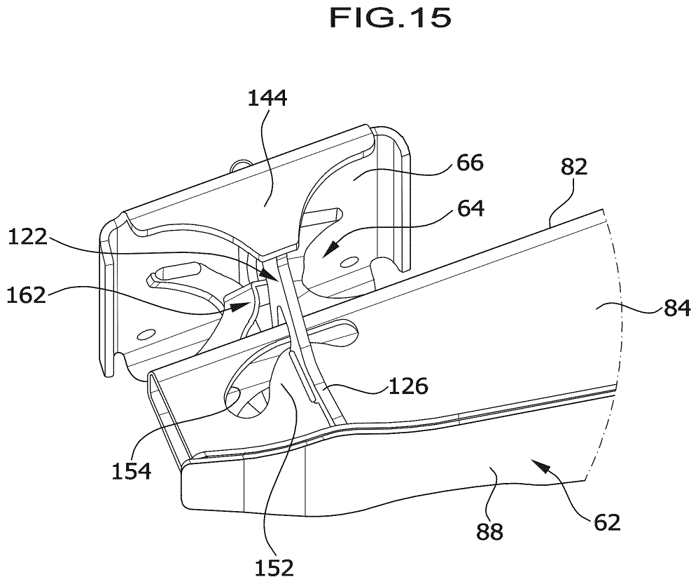

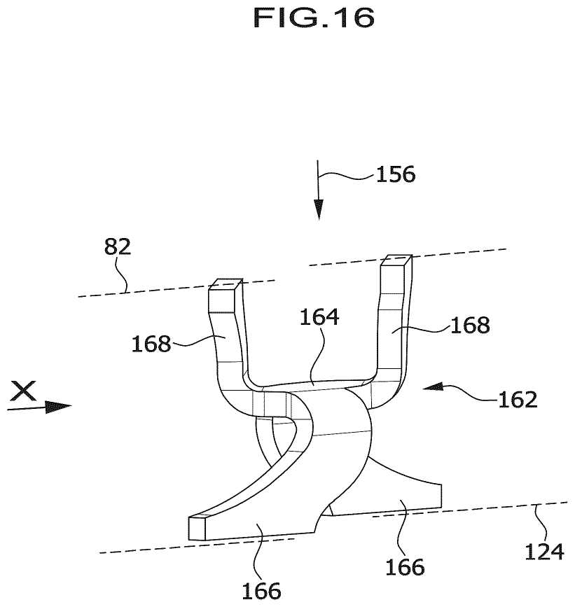

For this reason, in a second exemplary embodiment the connection elements 122, as illustrated in FIGS. 14, 15 and 16, are provided with additional energy absorption elements 162 that act in the region of the connection elements 122, between the impact body 62 and the respective foot 66.

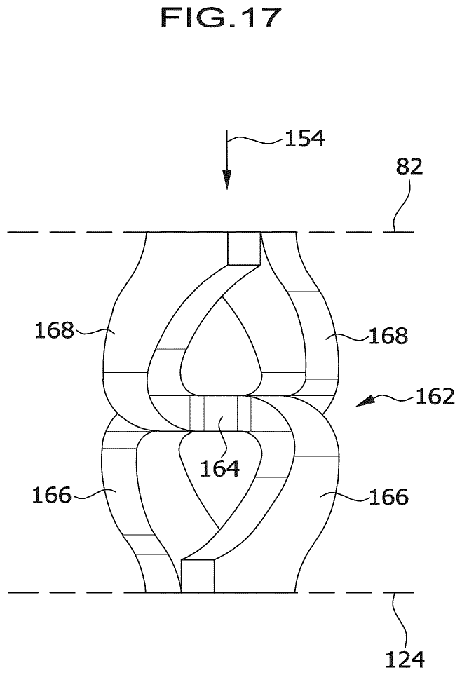

An additional energy absorption element 162 of this kind is illustrated in FIGS. 14 to 17 and comprises a central body 164 from which on one side support elements 166 extend to the central region 124 of the respective foot 66 and on the other side support elements 168 extend to the wall element 82 facing the vehicle, such that when the wall element 82 of the impact body 62 that faces the vehicle is moved in the direction of the respective foot 66, the support elements 168 and 166 deform and so, as the wall element 82 facing the vehicle moves in the direction of a crash 156, that is to say in the direction of the foot 66, absorb additional energy.

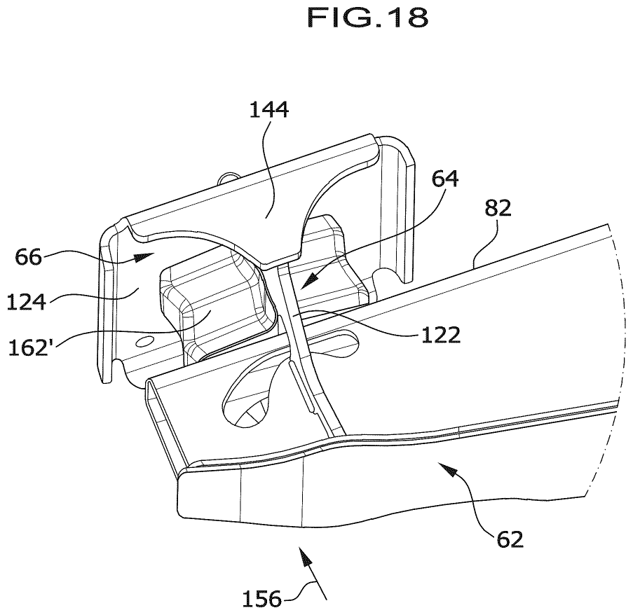

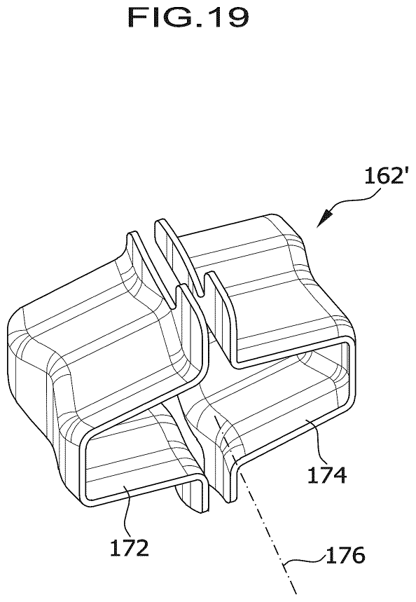

As illustrated in FIGS. 18 and 19, a first variant of an additional energy absorption element 162′ according to the invention is formed by two elements 172 and 174 that take a form similar to the halves of a shell relative to a geometric axis 176, are arranged to either side of the connection element 122, are supported at one side in the central region 124 of the respective foot 66 and at the other side against the wall element 82 of the impact body 62 that faces the vehicle, and extend between these with a cross section that varies in planes perpendicular to the geometric axis 176 such that, in the event of the wall element 82 facing the vehicle acting on these elements 172 and 174, because of the variation in cross section they are configured to fold up in the direction of a crash 156, which is approximately parallel to the geometric axis 176, in order to absorb energy.

Preferably, these elements 172 and 174 are firmly connected to the connection element 122 lying between them, and thus also provide additional stabilization of the connection element 122 between the respective foot 66 and the supporting web 142.

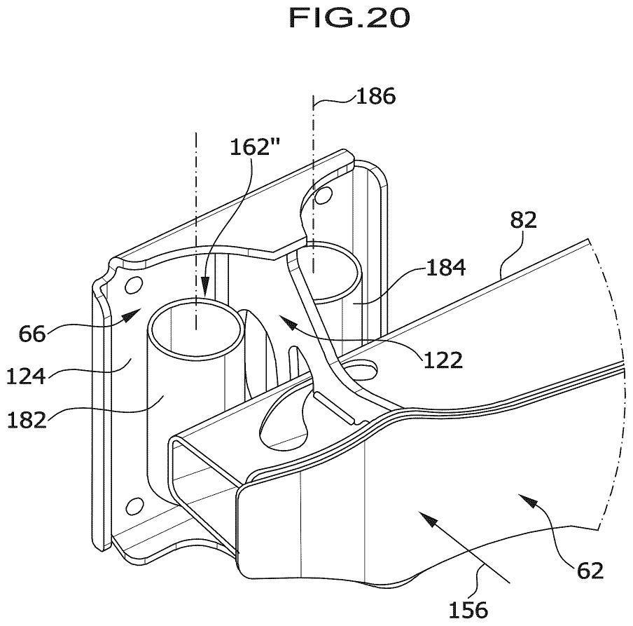

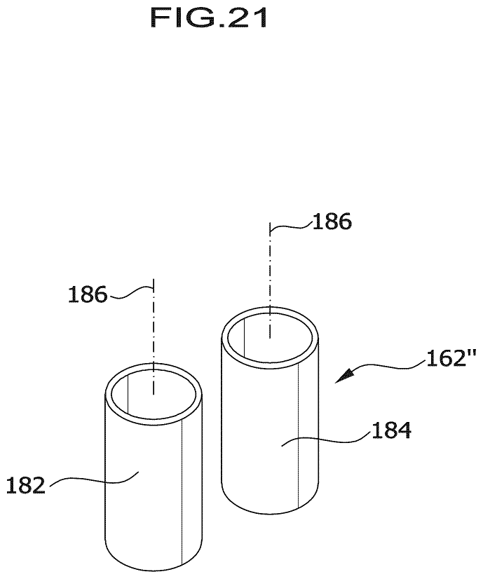

In a second variant of an additional energy absorption element 162″, illustrated in FIGS. 20 and 21, arranged to either side of the connection element 122, in each case running around a geometric axis 186 in the manner of a tube, are bodies 182 and 184 that abut on the one hand against the central region 124 of the respective foot 66 and on the other support the impact body 62, likewise to either side of the connection element 122, in the region of its wall element 82 facing the vehicle.

Here, the tube-like bodies 182 and 184 extend with their geometric axes 186 parallel to the central region 124 of the respective foot 66 and parallel to the planar extent of the connection element 122, with the result that in the event of a crash the tubular bodies 182 and 184 can deform in the direction of the crash 156, transversely to their geometric axes 186.

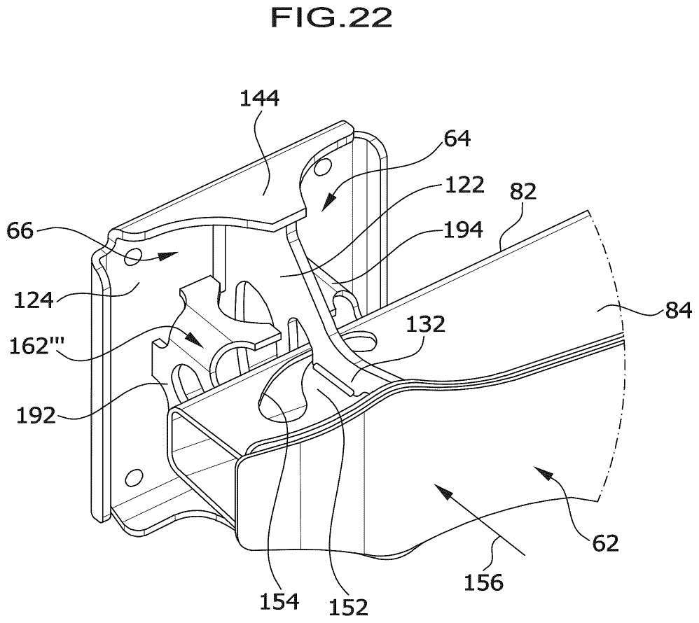

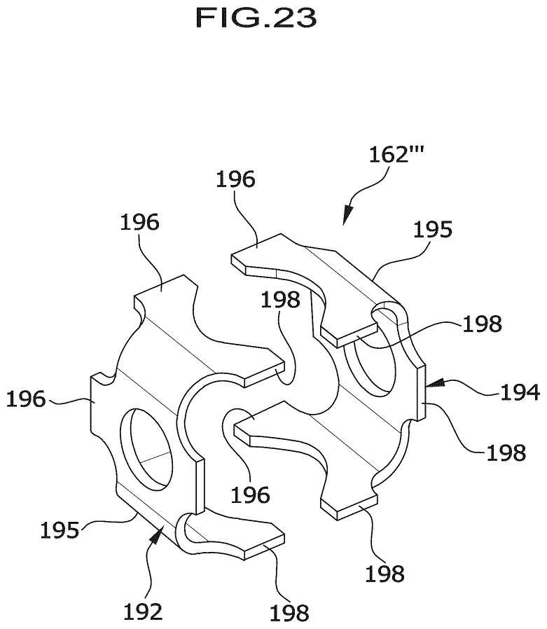

In a third variant of an additional energy absorption element 162′″, illustrated in FIGS. 22 and 23, arranged to either side of the connection element 122 are elements 192, 194 that are in a C shape or a bracket-like shape and are configured such that they are supported by a plurality of foot elements 196 arranged on a central body 195 against the central region 124 of the respective foot 66, on opposite sides of the respective connection element 122, and moreover are supported by one or more foot elements 198 arranged on the central body 195 against the wall element 82 of the impact body 62 that faces the vehicle.

In this case, the energy absorption element 162′″ extends by way of the elements 192 and 194 from the central region 124 of the respective foot 66 as far as the wall element 82 facing the vehicle, and is thus able to take up energy as a result of its shape folding in the direction of a crash 156.

1. A trailer coupling, comprising a trailer element, in particular a ball neck, and a vehicle attachment unit that carries the trailer element and is mountable or mounted on a vehicle rear, wherein the vehicle attachment unit comprises a crash unit, which is mountable on the vehicle rear below a bumper unit and has an impact body that extends transversely to a longitudinal center plane, which coincides with a vehicle longitudinal center plane, and deformation bodies arranged to either side of the longitudinal center plane, supporting the impact body in relation to the vehicle rear and maintaining a spacing therefrom, wherein the impact body of the crash unit is connected to the trailer element, and wherein the crash unit transmits to the vehicle rear all the forces that act on the trailer element when the trailer coupling is in use.

2. The trailer coupling as claimed in claim 1, wherein the crash unit is a crash unit adapted to the vehicle attachment unit for trailer operation.

3. The trailer coupling as claimed in claim 1, wherein the crash unit is a crash unit configured for the motor vehicle and usable on the motor vehicle without the provision of a trailer element.

4. The trailer coupling as claimed in claim 1, wherein a mounting base for mounting the trailer element is held on the impact body of the crash unit.

5. The trailer coupling as claimed in claim 1, wherein the impact body takes the form of a hollow body.

6. The trailer coupling as claimed in claim 1, wherein the mounting base is integrated into the impact body.

7. The trailer coupling as claimed in claim 1, wherein the impact body has a wall element facing the vehicle and a wall element facing away from the vehicle, and wherein an upper wall element facing away from a road and a lower wall element facing a road extend between these.

8. The trailer coupling as claimed in claim 7, wherein the wall elements are firmly connected to one another.

9. The trailer coupling as claimed in claim 1, wherein the wall element facing the vehicle and the upper and lower wall elements extending away from this are parts of a U-shaped profile.

10. The trailer coupling as claimed in claim 1, wherein the wall element facing away from the vehicle is convexly curved in the direction away from the wall element facing the vehicle.

11. The trailer coupling as claimed in claim 1, wherein the mounting base is connected, preferably detachably connected, to the wall element facing the vehicle and the wall element facing away from the vehicle and in particular also to the upper wall element.

12. The trailer coupling as claimed in claim 1, wherein the lower wall element facing a road has a cutout for installation of the mounting base.

13. The trailer coupling as claimed in claim 12, wherein the cutout is dimensioned such that it is possible to mount the mounting base with the trailer element previously mounted thereon.

14. The trailer coupling as claimed in claim 1, wherein held on the mounting base is a bearing unit, in particular a pivotal bearing unit, for the trailer element, by which the trailer element is pivotal from a working position into a rest position.

15. The trailer coupling as claimed in claim 14, wherein in the rest position the trailer element is at least partly, in particular entirely, received in the impact body.

16. The trailer coupling as claimed in claim 1, wherein, in the central region receiving the mounting base, the lower wall element is provided with a cutout of which the extent is such that the mounting unit, together with the pivotal bearing unit mounted thereon, is insertable between the wall element facing the vehicle and the wall element facing away from the vehicle and is mountable integrated into the impact body, such that in particular the entire mounting base, together with the bearing unit, lies within the impact body.

17. The trailer coupling as claimed in claim 16, wherein the mounting base runs obliquely relative to both the wall element facing away from the vehicle and the wall element facing the vehicle and abuts against them by way of mounting flanges.

18. The trailer coupling as claimed in claim 17, wherein the mounting unit has another mounting flange that is configured to abut against the upper wall element and to be connected thereto.

19. The trailer coupling as claimed in claim 1, wherein the mounting base, with the bearing unit mounted thereon and together with the trailer element held by the bearing unit, is insertable as a whole into the impact body by way of a cutout in the lower wall element.

20. The trailer coupling as claimed in claim 19, wherein the mounting base is connectable to the wall element facing the vehicle by way of a mounting flange and to the wall element facing away from the vehicle by way of a mounting flange and to the upper wall element by way of a mounting flange.

21. The trailer coupling as claimed in claim 1, wherein the mounting base is detachably connectable to the wall elements by way of the mounting flanges.

22. The trailer coupling as claimed in claim 1, wherein the mounting base is connectable to the wall elements by way of the mounting flanges using screws.

23. The trailer coupling as claimed in claim 1, wherein the mounting base is formed from molded parts made of flat material that are connected to one another and are for example mutually overlapping or arranged at a spacing from one another.

24. The trailer coupling as claimed in claim 1, wherein the mounting base is configured as a solid component that is connectable by way of edge regions respectively to the wall element facing the vehicle, the wall element facing away from the vehicle and the upper wall element.

25. The trailer coupling as claimed in claim 1, wherein the respective deformation body is supported on a foot that abuts or is configured to abut against the vehicle rear.

26. The trailer coupling as claimed in claim 25, wherein each of the feet has a central region that takes a planar form.

27. The trailer coupling as claimed in claim 25, wherein the feet are fixable to the vehicle rear by way of anchoring elements.

28. The trailer coupling as claimed in claim 27, wherein the feet are provided with anchoring elements acting on a stabilized region of the vehicle rear.

29. The trailer coupling as claimed in claim 1, wherein the deformation bodies have connection elements arranged between the respective foot and a holding region of the impact body.

30. The trailer coupling as claimed in claim 29, wherein the connection elements have fingers that are firmly connected to the holding region of the impact body.

31. The trailer coupling as claimed in claim 30, wherein the fingers abut against the lower and upper wall elements of the impact body and are connected to holding regions thereof.

32. The trailer coupling as claimed in claim 30, wherein the connection elements have a supporting web that extends between the fingers, and wherein provided in particular in the respective connection element between the supporting web and the foot is a central opening.

33. The trailer coupling as claimed in claim 32, wherein the wall element of the impact body that faces the vehicle abuts against the supporting web and is in particular firmly connected thereto.

34. The trailer coupling as claimed in claim 30, wherein the wall element facing away from the vehicle abuts on the fingers.

35. The trailer coupling as claimed in claim 30, wherein the holding regions, which are connected to the fingers, of the upper and lower wall elements are decoupled from the wall element facing the vehicle by cutouts.

36. The trailer coupling as claimed in claim 29, wherein the connection elements take a form such that in the event of a crash they deform as a whole in the direction of the crash.

37. The trailer coupling as claimed in claim 29, wherein additional energy absorption elements, which in the event of a crash deform in the direction of the crash, are associated with the connection elements of the deformation bodies.

38. The trailer coupling as claimed in claim 37, wherein the additional energy absorption elements are configured to take up forces that are transmitted from the trailer element to the impact body.

39. The trailer coupling as claimed in claim 37, wherein the additional energy absorption elements take the form of bodies that fold up in the direction of a crash.

40. The trailer coupling as claimed in claim 37, wherein the additional energy absorption elements have a central body and, extending from this, support elements that run at one side to the foot and at the other side to the impact body and in the event of a crash are foldable in the direction of the crash.

41. The trailer coupling as claimed in claim 37, wherein the additional energy absorption elements take the form of hollow bodies.

42. The trailer coupling as claimed in claim 41, wherein the hollow bodies extend around a geometric axis, and wherein the geometric axis runs in the direction of a crash or transversely to the direction of a crash.
